(19) United States
(12) Patent Application Publication
(10) Pub. No.: US 2004/0059844 A1
(43) Pub. Date: Mar. 25, 2004

(54) Network active I/O module with removable memory unit

(75) Inventors: Nicolas D.L. Jones, Kitchener (CA); Robert Wettermann, Inverness, IL (US); Bradley G. Woodman, Evanston, IL (US)

Correspondence Address: James J. Hill, Ste. 3000, 300 South Wacker Drive, Chicago, IL, 60606, US

(73) Assignee: Woodhead Industries, Inc.

(21) Appl. No.: 10/663,065

(22) Filed: Sep. 16, 2003

Related U.S. Application Data
(60) Provisional application No. 60/412,213, filed on Sep. 20, 2002.

(51) Int. Cl. G06F 13/00

(52) U.S. Cl. 710/15

(57) ABSTRACT

An Active Input/Output (I/O) Module forming a node of an industrial control network includes a housing for mounting a plurality of input and/or output serial data bus connectors, input and output device data connectors, and main and auxiliary power connectors, if desired. A programmed microprocessor unit is housed within the housing for controlling data and communication with a system main Programmable Logic Controller, or equivalent. A portion of the memory associated with the microprocessor for storing data specific to the node represented by the I/O module comprises a Removable Memory Unit, thus permitting the I/O module to be replaced upon failure with a new I/O module capable of receiving the Removable Memory Unit to re-constitute the I/O module without having to re-program the node-specific data on site.

### RELATED APPLICATION

This is a Non-Provisional Application of co-pending, co-owned provisional application No. 60/412,213, for “Network Active I/O Module With Removable Memory Unit”, filed on Sep. 20, 2002.

### FIELD OF THE INVENTION

The present invention relates to communication and control networks, especially industrial networks of the type used in the automation manufacturing and related industries. In particular, the invention is directed to an active input/output (I/O) module forming a node of an industrial control network.

### BACKGROUND OF THE INVENTION

Industrial control networks typically include a central controller in the form of a PC or Programmable Logic Controller or micro controller (sometimes referred to as the “Control Engine” and generically the controller). The controller typically includes a programmable microprocessor with sufficient memory and which communicates with various locations in a manufacturing facility by means of a main trunk or bus and branches or “drops”. The present invention is described in the context of an industrial control network employing the “DeviceNet” signal protocol and data format. Persons skilled in the art will appreciate that other network protocols (e.g. Profibus) may equally well be used and benefit from the advantages of the present invention, including control networks employing other data formats, such as Ethernet.

Located along the main trunk or communication line are a number of stations, arranged according to the topology of the application. Devices at each individual station may include input devices such as sensors, or output devices such as actuators. The system receives data from the sensors and communicates control data to the actuators, in a typical system, by means of an Active I/O Module located at a node in the network bus. Thus, data being generated by a sensor, which may, for example, generate data such as distance measurements, power status, last-time to maintenance, pneumatic or hydraulic pressure, is converted into digital data and transmitted back to the controller via an Active I/O Module. Similarly, digital data from the master controller may be communicated to an individual output device such as an hydraulic actuator through the Active I/O Module. Each network node as well as each individual device (whether an input or output) is represented by an address and the corresponding address information and associated data are stored and processed by the main processor as well as the Active I/O Module associated with a particular node or device or input of interest.

An Active I/O Module typically may include a number of separate input devices (16 for example) or a number of output devices (8 for example) or it may have as many as 8 inputs and 8 outputs, all in the same physical module. Other combinations or numbers of input/outputs are possible.

Each Active I/O Module (“module” for short) thus includes a plurality of data connectors, some of which may be associated with data inputs from sensors or the like, or simply a signal that a device is present or not present. Each module may also include a plurality of separate data connectors associated with outputs, either to control actuators or solenoid valves or to energize indicator lights, for example, on a display panel. Alternatively, a module may include data connectors associated only with input devices or output devices (i.e. not both types of devices). In addition, each module includes input and output bus connectors and optional power connectors. As used herein, a “module” includes the connectors, interconnections, firmware, software and microprocessor associated with a specific network node.

A problem associated with current modules in networks of the type discussed is that if the module becomes inoperative or any individual input or output connector is damaged, the user must remove the failed module, replace it with a new module, and then re-install the software parameters which are specific to that node in the network with which the module is associated because removal of the failed module also removes all data specific to that particular node, as will be further described below. Replacement of a module thus requires the attention and work of a skilled controls (or network) engineer because of the need to re-configure the module-specific software parameters associated with the failed or damaged module.

It may take considerable time to replace a defective or failed module because skilled controls engineers are not normally readily available on typical application sites. Moreover, it may be necessary for the person to obtain information and data from a separate source to identify the software and data associated with a particular failed module.

### SUMMARY OF THE INVENTION

In the present invention, the node-specific information, that is, the software and data associated with a specific module, includes the address of the module, including the address of each individual input or output of the module, as well as the electronic data sheet (or simply “data sheet” or “EDS” for short) parameters. These data sheet parameters depend to some extent upon the actual implementation of the system and the discretion of the design engineers. However, for purposes of explanation by providing an example, the node-specific data sheet parameters may include: (1) storage and maintenance data (for example, a log of errors detected, an identification of the current event being implemented, or the like); (2) network and node system parameters (for example, identification of the DHCP server associated with the node, service history of the node, serial number, and the like); (3) address information for the node (for example, MAC ID and IP address); (4) network communication parameters (for example, baud rate); and (5) identification of web pages for maintenance (for example, manuals and troubleshooting guides).

The present invention incorporates the node-specific parameters into a separate memory unit which is mounted externally of (i.e. not embedded in) the base of the physical casing which houses and encases the microprocessor and firmware for the module. The memory unit is easily accessible and readily removable from the mounting base. The memory unit is referred to as the “Removable Memory Unit” or RMU for short.

In the event of failure of any portion of the module or its microprocessor, or damage to any physical aspect of the module, such as a connector, the Removable Memory Unit is removed from the module, and the module (less the Removable Memory Unit) is replaced with a module of the same connectivity configuration. The Removable Memory Unit is readily connected to the new module by simply inserting or plugging it into the base, and supplies all of the original node-specific software and data associated with that node. There is thus no need to locate and enlist the services of a controls engineer since this task can be performed by any number of personnel normally on the job in a typical automation manufacturing environment.

Other features and advantages of the present invention will be apparent to persons skilled in the art from the following description of an illustrated embodiment, accompanied by the attached drawing wherein identical reference numerals will refer to like parts in the various views.

### BRIEF DESCRIPTION OF THE DRAWINGS

FIG. 1 is a functional block diagram of an Active I/O Module incorporating the present invention; and

FIG. 2 is a perspective view of a physical multiple-port Active I/O Module incorporating the present invention.

### DETAILED DESCRIPTION OF THE ILLUSTRATED EMBODIMENT

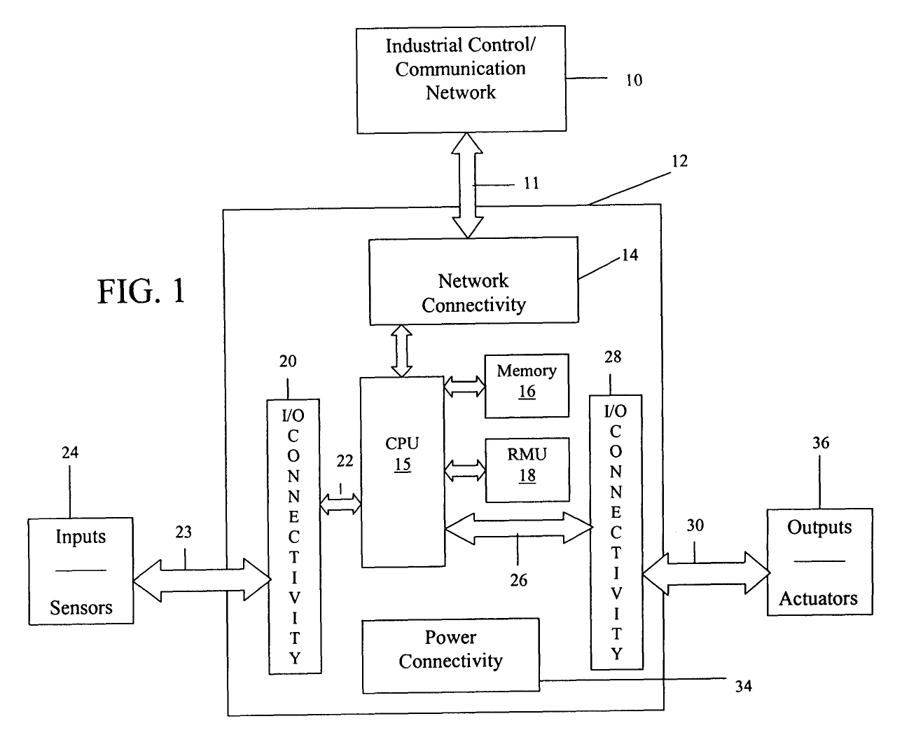

Referring first to FIG. 1, reference numeral 10 generally designates an industrial control/communication network which, in the illustrated embodiment, may employ the “DeviceNet” protocol. Such networks are in widespread use throughout the automation manufacturing industry. A branch or “drop” of the network trunk is diagrammically illustrated at 11, interconnecting the network trunk with an Active I/O Module (“module”) enclosed within the block 12.

By way of illustration, the trunk in the illustrated embodiment of a Device Net protocol will include five separate lines: two for data (Can_H and Can_L); two power lines (V+ and V−) and one common or “drain”.

The module 12 includes three different types of connectivity. The first is network connectivity diagrammatically shown within the block 14 in FIG. 1 includes data signal connectors (specifically, serial data connectors, discussed further below) for receiving data signals from and transmitting data signals to the Central Processor of the Controller (not shown) which is part of the network 10 via branch 11. The second type of connectivity is Input/Out (“I/O”) Connectivity, shown within blocks 20 and 28 for connecting respectively the CPU 15 of the module to the node inputs 24 (e.g. sensors) via I/O Connectivity 20 and node outputs 36 (e.g. actuator or valves) via I/O Connectivity 28. The third type of connectivity in the illustrated embodiment, which is optional, is power connectivity 34 which supplies power to the module.

The module 12 includes or houses a local CPU 15 which communicates through the Network Connectivity 14 with the Central Processor of the network 10. The local CPU 15 includes permanent memory 16 and a Removable Memory Unit 18, to be described further below. The CPU 15 is connected with I/O Connectivity 20 by means of an internal bus 22. The I/O Connectivity 20 communicates by means of an external bus 23 with the module input devices—that is, sensors or other input devices such as status indicators, diagrammatically included with the block 24.

The local CPU 15 also communicates by means of an internal bus 26 with second I/O Connectivity 28. The I/O Connectivity 28 communicates by means of an external bus 30 with devices to be controlled, or “outputs” such as actuators or valves as represented by block 36. Power may be supplied to external devices by means of Power Connectivity 34, which is optional and will be further described below.

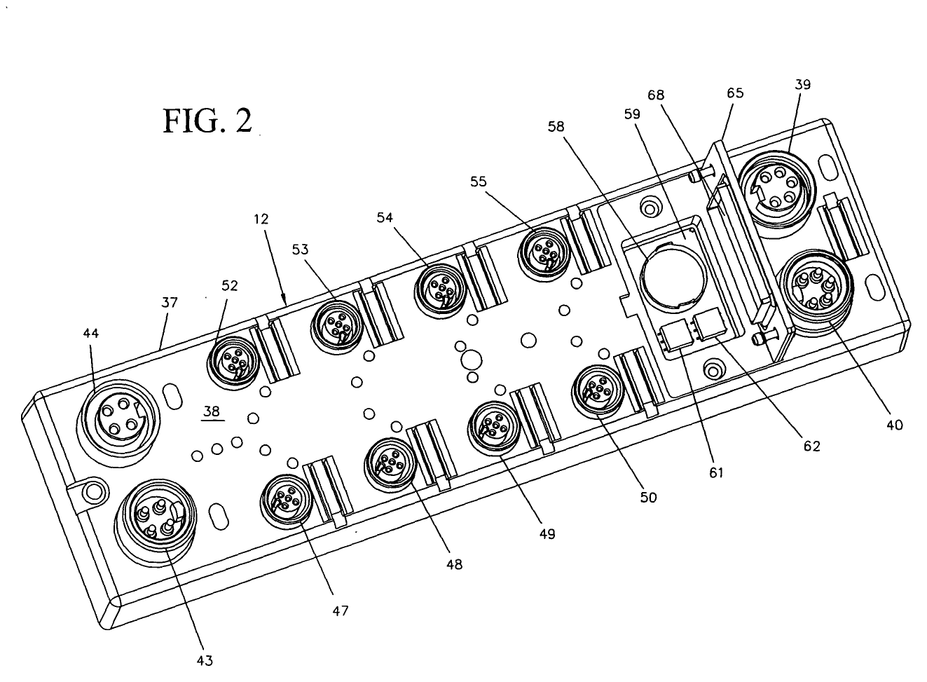

Turning now to FIG. 2, there is shown a physical embodiment of an Active I/O Module 12 including a rigid housing or casing 37 forming a base and which includes an upper mounting surface 38. In the embodiment illustrated in FIG. 2, the previously described network connectivity 14 includes a female (bus out) serial data connector 39 and a male (bus in) serial data connector 40. Each of the bus data connectors 39, 40 is a five-pole data connector commercially available from Woodhead Industries, Inc. of Deerfield, Ill. under the Trademark “Mini Change®”. By convention, moving counterclockwise from the key of the male connector 40 and clockwise from the keyway of the female connector 39, each of the connector poles is connected respectively to the drain, V+, V−, Can_H, and Can_L lines of the branch bus 11.

Turning now to the left side of the base or housing 12, the Power Connectivity 34 of the module 12 takes the form of two four-pole connectors, including a male power connector 43 and a female power connector 44. The incoming power line would be connected to the male power connector 43, and any continuation or power out line would be connected to the female power connector 44. The power connectors 43, 44 are also conventional, and available from Woodhead Industries, Inc. under the trademark “Mini Change®”.

In the illustrated embodiment, the I/O Connectivity 20, 28 takes the form of four input connectors 47, 48, 49 and 50 (I/O Connectivity 20), and four output connectors designated respectively 52, 53, 54 and 55 (I/O Connectivity 28). The connectors 47-50 and 52-55 are sometimes referred to as device data connectors since each couples to a device, whether an input device or an output device.

Each of the connectors 47-50 and 52-55 may be identical; and they may be obtained from Woodhead Industries, Inc. under the designation “Micro Change™”. Typically, they are five-pole connectors but the center pole is not used. Two of the remaining poles are used for V+ and V−. In the case of an input connector, one remaining pole (for example, Terminal No. 4) is used for input lines of odd numbers, and the numerically opposite pole is used for input lines of even numbers. Similarly, for the output connectors, the center pole is not used, and one other pole is not used. Of the three remaining poles, one is used for V+ for odd numbers, one is used for V+ for even numbers, and the remaining pole is used for V− auxiliary. These designations are known and familiar to persons skilled in the art. The input and output connectors are connected according to the nature of the sensor (three-wire or four-wire) or the device being controlled (again, three-wire or four-wire). A “device” is associated with a single unit, either a sensor input or a control output, whereas a “module” refers to a plurality of input/output ports, each associated with a separate connector.

The power connectivity 34 of FIG. 1 is optional. If chosen, the connectors 39, 40 are conventional and available through Woodhead Industries, Inc. under the trademark “Mini Change™”.

Returning to FIG. 2, the Removable Memory Unit 18 of FIG. 1 may take the form of a mobile or removable memory chip of the type commercially available from Maxim Integrated Products of Sunnyvale, Calif. marketed under the trademark “I-Button™”, specifically Model DS1971-F5 256-bit Memory Unit. The Removable Memory Unit is thus in the form of a disc 58 removably mounted in a recess 59 formed in the top surface 38 of the housing 37. This Removable Memory Unit is provided with leads connected to a mounting socket such that the memory unit may be removed from the socket which provides connections to the CPU 15. Also within the recess 59 are first and second rotary switches 61, 62 for setting the most and least significant digits respectively identifying the node associated with a particular module being replaced. A hinged cover 65 can be mounted to the top 38 of the housing 37, and the cover 65 may include a plastic or glass pane 68, permitting a user to quickly observe the presence or absence of the Removable Memory Unit 58 while providing protection against dust, water spray, and the other conditions of an industrial environment.

The following data provides an example of the information typically contained in the Removable Memory Unit.

### INFORMATION/DATA IN REMOVABLE MEMORY UNIT

| TERMINOLOGY | DEFINITION |
|---|---|
| NODE ADDRESS | Actual address of the physical device (i.e., Active |
| | I/O Module). |
| EDS (Electronic | Settable parameters for the module, such as baud |
| Data Sheets) | rate, output state, type of messaging. |
| PARAMETERS | |
| BAUD RATE | Transmission rate of the data being transmitted. |
| ERROR LOG | File containing all error messages either on the |
| | network or from the module associated with the |
| | RMU. |
| INITIAL STARTUP | Values of the EDS or GSD parameters at startup |
| PARAMETERS | and date and time when the device was initially |
| AND DATE AND | started. |
| TIME | |
| MAC ID | Media Access Control Identifier for the physical |
| | device. Similar to the node address for DeviceNet. |
| CURRENT EVENT | Status of any current event. |
| WEB PAGES | (e.g., Manuals and Troubleshooting Guides) in http |
| | format. |
| IP (Internet | Address for the NIC (Network Interface Card) |
| Protocol) | for the module. |
| ADDRESS | |
| TCP/IP (Trans- | Contains the following parameters: |
| mission Control | IP address, DNS (Domain Name System), |
| Protocol/Internet | WINS (Windows Internet Names Services) |
| Protocol) | Address, IP Forwarding. |
| CONFIGURATION | |
| DHCP | Allows network administrators to assign |
| (Dynamic Host | IP addresses to devices over Ethernet. |
| Configuration | |
| Protocol) SERVER | |
| DOMAIN NAME | Listing of IP addresses for connections and services. |
| SYSTEM (DNS) | |
| TABLES | |
| GSD | Similar to the EDS parameters for DeviceNet, |
| PARAMETERS | except for Profibus network protocol. |
| SERVICE | Log of maintenance services or firmware upgrades. |
| HISTORY | |
| SERIAL NUMBER | Assigned for each module. |
| DISTRIBUTED | Control program for only the local module |
| CONTROL | activating inputs and outputs locally (i.e., |
| PROGRAM | those being fed through the module under |
| | replacement). |
| ACCESS LOG | File containing all users who access the module. |
| FIRMWARE | Program containing code for running the module. |
| PASSWORD | File containing password permitting access to |
| | the module. |
| AUTHENTICA- | Process of user logging into the system including |
| TION | the user name and password. |
| NETWORK | Network system parameters not stored elsewhere. |
| SYSTEM | |
| PARAMETERS | |
| ACCOUNT | The remaining amount of time for the user to access |
| BALANCE | the device. |
| EXTRA | Additional memory the programmer needs which is |
| WORKING | not currently available on the main circuit |
| MEMORY | board of the module. |

The above data may fall into separate categories. For example, the NODE ADDRESS, MAC ID, and IP ADDRESS are all associated with the address of the Active I/O Module under repair or replacement. Another category is Node or Network Configuration Parameters. This would include EDS PARAMETERS, GSD PARAMETERS, NETWORK SYSTEM PARAMETERS, TCP/IP CONFIGURATION, DHCP SERVER, and DOMAIN NAME SYSTEM TABLES. Another category includes Storage and Maintenance Data. This would include ERROR LOG, INITIAL STARTUP PARAMETERS AND DATE AND TIME, CURRENT EVENT, WEB PAGES, SERVICE HISTORY, SERIAL NUMBER, DISTRIBUTED CONTROL PROGRAM, ACCESS LOG, FIRMWARE, PASSWORD, AUTHENTICATION, ACCOUNT BALANCE and EXTRA WORKING STORAGE.

It will thus be apparent to those skilled in the art that replacement of an Active I/O Module using the Replaceable Memory Unit with the data and information stored as indicated above has a number of distinct advantages over the replacement of existing Active I/O Modules. The first is the speed of replacement. Since it is not necessary to first locate a controls engineer and then to install the new firmware and software into the replacement unit after identifying the data that needs to be installed for a particular node in the network system, the replacement time is greatly reduced. The cost of replacement is also reduced, particularly considering costs associated with node or system downtime. Further, any modification of the manufacturing system itself associated with a particular node which requires changes in the node parameters is also facilitated since it can be accomplished by using the same module base without disconnecting it, and simply replacing the Removable Memory Unit.

Having thus disclosed one embodiment of the invention, persons skilled in the art may substitute equivalent elements for those disclosed and modify certain of the structure disclosed while continuing to practice the principles of the invention. It is therefore, intended that all such modifications and substitutions be covered as they are embraced within the scope of the appended claims.

We claim:

1. An active connectivity module representing a node in an industrial control network comprising;
a housing;
first and second bus data connectors mounted to said housing and providing connectivity to a data bus of said network;
a plurality of device data connectors mounted to said housing and each associated with an input device or an output device;
a central processor unit connected to said network and to said data bus and input devices or output devices by means of said device data connectors; and
a memory module coupled to said central processor unit and removably mounted on said housing, said memory unit in signal communication with said central processor unit, said memory unit storing at least address data representing the address of a network node with which said module is associated, and network configuration data including data sheet parameters associated with said node.

2. The apparatus of claim 1 wherein said device data connectors comprise a plurality of data connectors associated respectively with corresponding input devices.

3. The apparatus of claim 1 wherein said device data connectors comprise a plurality of data connectors each associated with an output device.

4. The apparatus of claim 3 wherein said device data connectors include a plurality of data connectors each associated with an input device whereby said module is capable of communicating with both input devices and output devices.

5. The apparatus of claim 1 wherein said address data includes data representative of the node address, the MAC identification, and an IP address associated with the address of said node.

6. The apparatus of claim 5 wherein said data stored in said removable memory unit comprises the network configuration parameters including data sheet parameters, GDS parameters, network system parameters, TCP/IP configuration and DHCP server information.

7. The apparatus of claim 6 wherein said data stored in said removable memory module includes storage and maintenance data, including an error log and initial startup parameters and date and time data.
